(19) United States
(12) Patent Application Publication
(10) Pub. No.: US 2026/0290839 A1
(43) Pub. Date: Sep. 24, 2026

(54) ELECTRODE FOR SECONDARY BATTERY AND METHOD OF MANUFACTURING SECONDARY BATTERY

(71) Applicant: SAMSUNG SDI CO., LTD., Yongin-si (KR)

(72) Inventor: Gwanghun KIM, Yongin-si (KR)

(21) Appl. No.: 19/312,565

(22) Filed: Aug. 28, 2025

(30) Foreign Application Priority Data
Mar. 18, 2025 (KR) 10-2025-0034671

(51) Int. Cl. H01M 4/66; H01M 4/04; H01M 50/534; H01M 50/536

(52) U.S. Cl. CPC H01M 4/667; H01M 4/0404; H01M 4/0471; H01M 4/661; H01M 4/668; H01M 50/534; H01M 50/536

(57) ABSTRACT

An electrode may include a composite substrate including a polymer layer extending in a first direction, and a first metal layer and a second metal layer each disposed on surfaces of the polymer layer with respect to a second direction, a first electrode tab coupled to the first metal layer, and a second electrode tab coupled to the second metal layer. Each of the first electrode tab and the second electrode tab may include a first substrate layer contacting the first metal layer or the second metal layer, and a second substrate layer on the first substrate layer. A welding strength between the first or second metal layer and the first substrate layer of the first or second electrode tab may be greater than a welding strength between the first or second metal layer and the second substrate layer of the first or second electrode tab.

### CROSS-REFERENCE TO RELATED APPLICATION

The present application claims priority to and the benefit of Korean Application No. 10-2025-0034671, filed on Mar. 18, 2025, in the Korean Intellectual Property Office, the entire disclosure of which is incorporated by reference herein.

### BACKGROUND

### Field

The present disclosure relates to an electrode for a secondary battery and a method of manufacturing a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Recently, customer demand has risen for reducing weight of secondary batteries used in portable IT devices and automobiles. Conventional approaches devised to reduce battery weight of secondary batteries include using thinning materials, such as substrates, separators, and exterior members applied to secondary batteries or improving physical properties of active materials to increase energy density of secondary batteries. However, employing these conventional approaches can create safety risks for secondary batteries.

The above information disclosed in this Background section is for enhancement of understanding of the background of the present disclosure, and therefore, it may contain information that does not constitute related (or prior) art.

### SUMMARY

An object that embodiments of the present disclosure seek to achieve is to provide an electrode for a secondary battery and a method of manufacturing a secondary battery that can resolve the above-described issues.

These and other aspects and features of the present disclosure will be described in or will be apparent from the following description of embodiments of the present disclosure.

According to some embodiments of the present disclosure that solve the above technical object, an electrode may include a composite substrate including a polymer layer extending in a first direction, a first metal layer disposed on one surface of the polymer layer (the one surface being orthogonal to a second direction), and a second metal layer disposed on another surface of the polymer layer (the another surface being orthogonal to the second direction); a first electrode tab coupled to the first metal layer; and a second electrode tab coupled to the second metal layer. The first electrode tab may include a first substrate layer welded to the first metal layer, and a second substrate layer disposed on the first substrate layer of the first electrode tab. The second electrode tab may include a first substrate layer welded to the second metal layer, and a second substrate layer disposed on the first substrate layer of the second electrode tab. A welding strength between the first substrate layer of the first electrode tab and the first metal layer or between the first substrate layer of the second electrode tab and the second metal layer substrate layer may be greater than a welding strength between the second substrate layer of the first electrode tab and the first metal layer or between the second substrate layer of the second electrode tab and the second metal layer.

In some embodiments, the first substrate layer of the first electrode tab and the first substrate layer of the second electrode tab may include at least nickel. The second substrate layer of the first electrode tab and the second substrate layer of the second electrode tab may include at least copper.

In some embodiments, with respect to the second direction, a thickness of the first substrate layer of the first electrode tab may be greater than or equal to 2.5% of a thickness of the first electrode tab.

In some embodiments, the composite substrate further may include a coated portion of the first metal layer and the second metal layer where an active material layer may be located on the first metal layer or on the second metal layer and an uncoated portion of the first metal layer and the second metal layer positioned at an end portion of the composite substrate with respect to the first direction and exposing the first metal layer or the second metal layer. The first substrate layer of the first electrode tab and the first substrate layer of the second electrode tab may be welded to the uncoated portion.

In some embodiments, the first electrode tab may include a first region where the first electrode tab contacts the first metal layer, and a second region where the first electrode tab protrudes beyond the first metal layer with respect to the first direction. The second electrode tab may include a third region where the second electrode tab contacts the second metal layer, and a fourth region where the second electrode tab protrudes beyond the second metal layer with respect to the first direction.

In some embodiments, the first substrate layer of the first electrode tab may be positioned in the first region of the first electrode tab. The first substrate layer of the second electrode tab may be positioned in the third region of the second electrode tab.

In some embodiments, with respect to the first direction, a width of the first substrate layer of the first electrode tab and a width of the first substrate layer of the second electrode tab may be from about 3 mm to about 5 mm.

In some embodiments, the first substrate layer of the first electrode tab may be positioned in the first region of the first electrode tab. The first substrate layer of the second electrode tab may be positioned in at least a portion of the third region of the second electrode tab and at least a portion of the fourth region of the second electrode tab.

In some embodiments, at least a portion, of the first electrode tab, in the second region and at least a portion, of the second electrode tab, in the fourth region may be coupled to each other.

In some embodiments, an electrical conductivity of the second substrate layer of the first electrode tab may be greater than an electrical conductivity of the first substrate layer of the first electrode tab, or an electrical conductivity of the second substrate layer of the second electrode tab may be greater than an electrical conductivity of the first substrate layer of the second electrode tab.

In some embodiments of the present disclosure, a method of manufacturing an electrode may include layering a composite substrate including a polymer layer extending in a first direction, a first metal layer disposed on one surface of the polymer layer (the one surface being orthogonal to a second direction), and a second metal layer disposed on another surface of the polymer layer (the another surface being orthogonal to the second direction); coupling a first electrode tab to the first metal layer, the first electrode tab including a first substrate layer and a second substrate layer; coupling a second electrode tab to the second metal layer, the second electrode tab including a first substrate layer and a second substrate layer; welding the first substrate layer of the first electrode tab to the first metal layer; layering the second substrate layer of the first electrode tab on the first substrate layer of the first electrode tab; welding the first substrate layer of the second electrode tab to the second metal layer; and layering the second substrate layer of the second substrate layer on the first substrate layer of the second electrode tab. A welding strength between the first substrate layer of the first electrode tab and the first metal layer or between the first substrate layer of the second electrode tab and the second metal layer substrate layer may be greater than a welding strength between the second substrate layer of the first electrode tab and the first metal layer or between the second substrate layer of the second electrode tab and the second metal layer.

In some embodiments, the method further may include forming the first substrate layer of the first electrode tab and the first substrate layer of the second electrode tab at least with nickel and forming the second substrate layer of the first electrode tab and the second substrate layer of the second electrode tab at least with copper.

In some embodiments, the method further may include configuring, with respect to the second direction, a thickness of the first substrate layer of the first electrode tab to be greater than or equal to 2.5% of a thickness of the first electrode tab.

In some embodiments, preparing the composite substrate may include applying an active material on the composite substrate so that the composite substrate may include a coated portion of the first metal layer and the second metal layer where an active material layer may be located on the first metal layer or on the second metal layer and an uncoated portion of the first metal layer and the second metal layer positioned at an end portion of the composite substrate with respect to the first direction and exposing the first metal layer or the second metal layer.

In some embodiments, coupling the first electrode tab to the first metal layer may include welding the first substrate layer of the first electrode tab to the uncoated portion.

In some embodiments, the first electrode tab may include a first region and a second region. The second electrode tab may include a third region and a fourth region. The method further may include positioning the first electrode tab so that a portion of the first electrode tab in the first region contacts the first metal layer, configuring the first electrode tab so that a portion of the first electrode tab in the second region protrudes beyond the first metal layer with respect to the first direction, positioning the second electrode tab so that a portion of the second electrode tab in the third region contacts the second metal layer, and configuring the second electrode tab so that a portion of the second electrode tab in the fourth region protrudes beyond the second metal layer with respect to the first direction.

In some embodiments, the method further may include positioning the first substrate layer of the first electrode tab in the first region of the first electrode tab and positioning the first substrate layer of the second electrode tab in the third region of the second electrode tab.

In some embodiments, the method further may include configuring the first substrate layer of the first electrode tab and the first substrate layer of the second electrode tab to each may have a width, with respect to the first direction, substrate layer from about 3 mm to about 5 mm.

In some embodiments, the method further may include positioning the first substrate layer of the first electrode tab to be in the first region of the first electrode tab and positioning the first substrate layer of the second electrode tab to be in at least a portion of the third region of the second electrode tab and at least a portion of the fourth region of the second electrode tab.

In some embodiments, the method further may include coupling at least a portion, of the first electrode tab, in the second region and at least a portion, of the second electrode tab, in the fourth region to each other.

According to some embodiments of the present disclosure, because a polymer layer is formed inside the composite substrate, the weight of the substrate itself may be reduced. Compared with using a substrate formed solely of metal layers, an energy density of the battery may be improved.

According to some embodiments of the present disclosure, because the first electrode tab and the second electrode tab are coupled, the first metal layer and the second metal layer of the composite substrate may be electrically connected to each other. Accordingly, it is possible to prevent a problem in which current is induced only through one of the metal layers disposed on both surfaces of the composite substrate, a problem preventing a reduction in battery efficiency.

According to some embodiments of the present disclosure, by configuring the electrode tabs in a double-layer structure and forming, as the surface contacting the metal layer of the composite substrate, a first substrate layer plated with nickel, the electrode tabs may be stably coupled to the composite substrate. In addition, because the second substrate layer, which does not contact the metal layer of the composite substrate, is formed of a material having high electrical conductivity, stable current flow may be achieved between the composite substrate and the electrode tabs, or between the first electrode tab and the second electrode tab.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a battery according to some embodiments of the present disclosure.

FIG. 2 is a cross-sectional view of a composite substrate according to some embodiments of the present disclosure.

FIG. 3 is a cross-sectional view of an electrode manufactured using a composite substrate according to some embodiments of the present disclosure.

FIG. 4 is a plan view of an electrode manufactured using a composite substrate according to some embodiments of the present disclosure.

FIG. 5 is a cross-sectional view of a first electrode tab according to some embodiments of the present disclosure.

FIG. 6 is a cross-sectional view of an electrode in which a first electrode tab and a second electrode tab are coupled to each other according to some embodiments of the present disclosure.

FIG. 7 is a cross-sectional view of a first electrode tab according to some embodiments of the present disclosure.

FIG. 8 is a cross-sectional view of an electrode in which a first electrode tab and a second electrode tab are coupled to each other according to some embodiments of the present disclosure.

FIG. 9 is a cross-sectional view of an electrode in which a first electrode tab and a second electrode tab are coupled to each other according to some embodiments of the present disclosure.

FIG. 10 is a flowchart illustrating an electrode-manufacturing method according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes or thicknesses of areas shown in the drawings may be exaggerated for clarity of explanation. Therefore, the sizes shown in the drawings are merely for ease of understanding and are not intended to limit the present disclosure. Throughout the specification, the same reference numerals refer to the same or similar components.

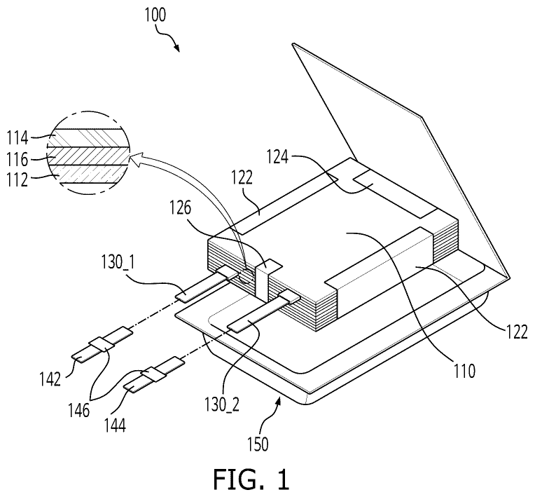

FIG. 1 illustrates a battery 100 according to some embodiments of the present disclosure. As shown, the battery 100 may include a case 150 and an electrode assembly 110 disposed inside the case 150.

The electrode assembly 110 may include a first electrode 112, a second electrode 114, and a separator 116. The electrode assembly 110 may have a stack type structure in which a plurality of sheets—namely, the first electrode 112 and the second electrode 114—are alternately stacked with the separator 116 (which is an insulator) interposed between the first electrode 112 and the second electrode 114. However, the present disclosure is not limited thereto, and the electrode assembly 110 may have a winding-type structure in which the first electrode 112 and the second electrode 114 are wound with the separator 116 interposed between the first electrode 112 and the second electrode 114. In addition, the electrode assembly 110 may be a Z-stack electrode assembly 110 in which the first electrode 112 and the second electrode 114 are inserted on both sides of a separator 116 folded in a Z-stack.

One or more electrode assemblies 110 may be stacked so that long sides of the one or more electrode assemblies 110 are adjacent to each other and may be housed in the case 150, and the number of electrode assemblies 110 is not limited in the present disclosure. The first electrode 112 of the electrode assembly 110 may serve as a negative electrode, and the second electrode 114 may serve as a positive electrode, but the opposite arrangement is also possible.

The first electrode 112 may be formed by coating an active material such as graphite or carbon on a substrate and may include an uncoated region (an uncoated portion). A first electrode tab 130_1 electrically connected to the uncoated portion may be formed or connected at one side of the first electrode 112. The first electrode tab 130_1 may be a substrate tab using a part of the uncoated portion. Additionally, or alternatively, a plurality of first electrode tabs 130_1 may be formed or connected at one side of the first electrode 112. Each of the plurality of first electrode tabs 130_1 may protrude to a specific position of the electrode assembly 110, and the plurality of first electrode tabs 130_1 may be connected to form a lead tab.

The second electrode 114 may be formed by coating an active material such as a transition-metal oxide on a substrate and may include an uncoated portion where the active material is not coated. A second electrode tab 130_2 electrically connected to the uncoated portion may be formed or connected at one side of the second electrode 114. The second electrode tab 130_2 may be a substrate tab using a part of the uncoated portion. Additionally, or alternatively, a plurality of second electrode tabs 130_2 may be formed or connected at one side of the second electrode 114. Each of the plurality of second electrode tabs 130_2 may protrude to a specific position of the electrode assembly 110, and the plurality of second electrode tabs 130_2 may be connected to form a lead tab.

The substrates of the first electrode 112 and the second electrode 114 may be composite substrates. The substrates of the first electrode 112 and the second electrode 114 may include a polymer layer and metal layers disposed on both surfaces of the polymer layer.

The first electrode tab 130_1 may be a current flow path between the first electrode 112 and a first strip terminal 142. A tab film 146 for insulation from the case 150 may be attached to the first strip terminal 142. The second electrode tab 130_2 may be a current flow path between the second electrode 114 and a second strip terminal 144. A tab film 146 for insulation from the case 150 may be attached to the second strip terminal 144.

Protective tapes 122, 124, 126 may be attached to a surface of the electrode assembly 110. The protective tapes 122, 124, 126 may be attached along a side periphery of the electrode assembly 110, and positions of the protective tapes 122, 124, 126 and a number of the protective tapes 122, 124, 126 are not limited in the present disclosure. The protective tapes 122, 124, 126 may align the electrode assembly 110 and may protect the electrode assembly 110 from external impacts.

The case 150 may form an overall exterior of the battery 100 and may provide a space in which the electrode assembly 110 is accommodated. The case 150 may be made of a conductive metal such as stainless steel (SUS), aluminum, an aluminum alloy, or nickel-plated steel, or the case 150 may be made of a laminate film or plastic forming a pouch.

In FIG. 1, the case 150 is depicted as a pouch-type case, and the battery 100 is depicted as a pouch-type battery, but the present disclosure is not limited thereto. The battery 100 may be a battery of any form such as, for example, a prismatic type, a cylindrical type, or a pouch type.

The battery 100 may be a kind of secondary battery. For example, the battery 100 may be a lithium battery or a sodium battery, but the present disclosure is not limited thereto, and the battery 100 includes all batteries that can repeatedly provide electricity through charging and discharging.

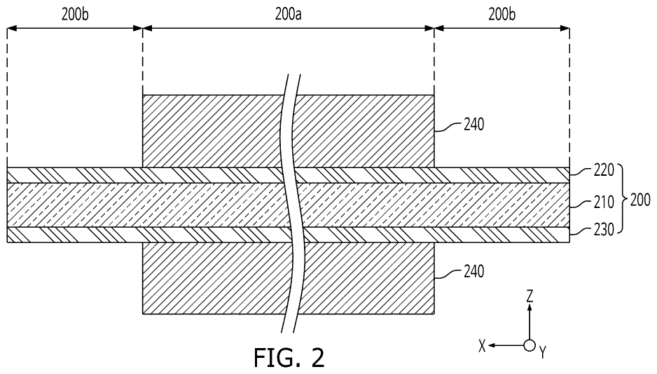

FIG. 2 is a cross-sectional view of a composite substrate 200 according to some embodiments of the present disclosure. The composite substrate 200 may include a polymer layer 210 extending in a first direction (e.g., an X direction). Further, layered a second direction (e.g., a Z direction) that is a thickness direction of the polymer layer 210, a first metal layer 220 may be disposed on one surface of the polymer layer 210, and a second metal layer 230 may be disposed on another surface of the polymer layer 210. Particularly, the first metal layer 220 may be disposed on one surface of the polymer layer 210, and the second metal layer 230 may be disposed on the other surface of the polymer layer 210 opposite to the one surface.

The first metal layer 220 and the second metal layer 230 may be formed of conductive materials. In some embodiments, the first metal layer 220 and the second metal layer 230 may include copper, a copper alloy, nickel, or a nickel alloy. In some embodiments, the first metal layer 220 and the second metal layer 230 may include aluminum or an aluminum alloy. In still another example, the first metal layer 220 may include copper, a copper alloy, nickel, or a nickel alloy, and the second metal layer 230 may include aluminum or an aluminum alloy.

The first metal layer 220 and the second metal layer 230 may be disposed on the polymer layer 210 in the form of thin films. The first metal layer 220 and the second metal layer 230 may be deposited on the polymer layer 210 by a vapor-phase deposition method in a vacuum state or may coat a surface of the polymer layer 210 by an electroless-plating method or an electroplating method. A thickness of each of the first metal layer 220 and the second metal layer 230 may be from about 1.0 μm to about 3.0 μm, but the present disclosure is not limited thereto. In addition, a thickness d3 of the polymer layer 210 may be from about 4.0 μm to about 10.0 μm, but the present disclosure is not limited thereto.

In some embodiments, the polymer layer 210 and the first and second metal layers 220, 230 may be stably coupled. Accordingly, separation of the polymer layer 210 and the first and second metal layers 220, 230 during a manufacturing process of the electrode can be prevented.

Further, because the polymer layer 210 is formed inside the composite substrate 200, the weight of the substrate itself can be reduced. Thus, an energy density of the battery can be improved.

An active material layer may be coated on the first and second metal layers 220, 230 of the composite substrate 200. The composite substrate 200 may include a coated portion 200a in which an active material layer 240 is disposed on the first metal layer 220 or the second metal layer 230, and an uncoated portion 200b in which the active material layer 240 is not disposed and thus the first metal layer 220 or the second metal layer 230 is exposed. The uncoated portion 200b may be positioned at an end portion of the composite substrate 200 with respect to the first direction (e.g., the X direction).

In some embodiments, the first metal layer 220 and the second metal layer 230 disposed on both surfaces of the polymer layer 210 may include aluminum or an aluminum alloy. The active material layer 240 disposed on the first metal layer 220 or the second metal layer 230 may include a positive-electrode (or cathode) active material, and an electrode manufactured by using the composite substrate 200 may function as a positive electrode (or cathode). Alternatively, the first metal layer 220 and the second metal layer 230 disposed on both surfaces of the polymer layer 210 may include copper, a copper alloy, nickel, or a nickel alloy. Further, the active material layer 240 disposed on the first metal layer 220 or the second metal layer 230 may include a negative-electrode active material, and an electrode manufactured by using the composite substrate 200 may function as a negative electrode.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The negative electrode active material may include a material that reversibly intercalates/deintercalates lithium ions, a lithium metal, a lithium metal alloy, a material capable of doping/dedoping lithium, or a transition metal oxide.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

Because the polymer layer 210 is interposed between the first metal layer 220 and the second metal layer 230 of the composite substrate 200, the first metal layer 220 and the second metal layer 230 may not be electrically connected to each other. To prevent a problem in which current is induced only through one of the first and second metal layers 220, 230 disposed on both surfaces of the polymer layer 210 (which reduces battery efficiency), separate conductors (e.g., electrode tabs) may be connected to the first metal layer 220 and the second metal layer 230.

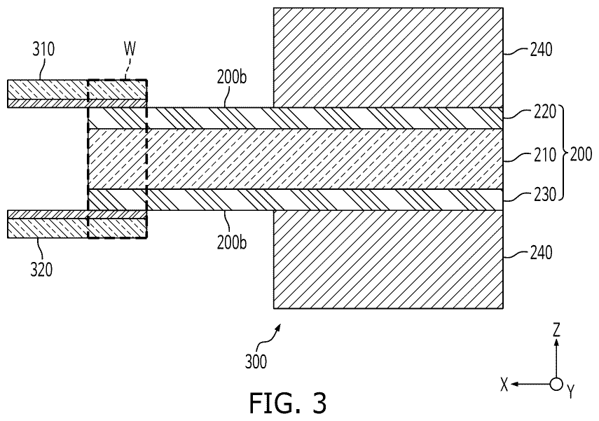

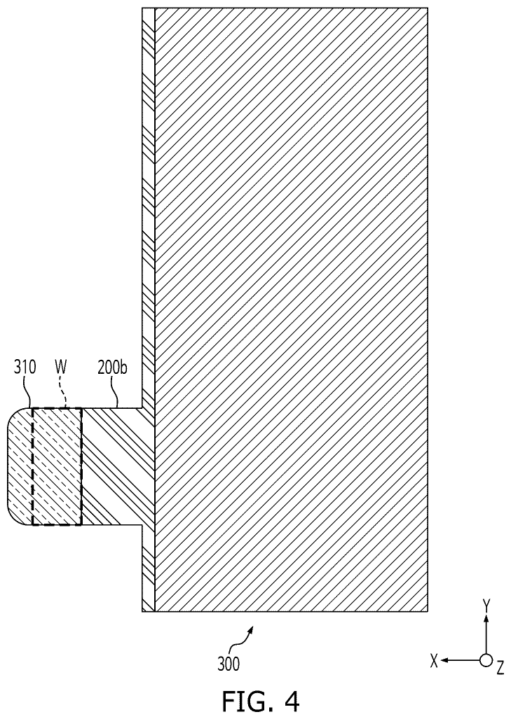

FIG. 3 is a cross-sectional view of an electrode 300 manufactured using a composite substrate 200 according to some embodiments of the present disclosure. FIG. 4 is a plan view of the electrode 300 manufactured using a composite substrate 200 according to some embodiments of the present disclosure. Referring to FIGS. 3 and 4, the electrode 300 may include a composite substrate 200 and first and second electrode tabs 310 and 320 coupled to the composite substrate 200.

The composite substrate 200 may include the polymer layer 210 extending in a first direction (e.g., the X direction) and first and second first and second metal layers 220 and 230 respectively disposed on both surfaces of the polymer layer 210. In addition, the composite substrate 200 may include a coated portion in which an active material layer 240 is disposed on the first metal layer 220 or the second metal layer 230 and an uncoated portion 200b in which the active material layer 240 is not disposed so that the first metal layer 220 or the second metal layer 230 is exposed.

The first and second electrode tabs 310, 320 may be coupled to the uncoated portion 200b of the composite substrate 200. In some embodiments, the first electrode tab 310 may be coupled to the first metal layer 220 of the composite substrate 200, and the second electrode tab 320 may be coupled to the second metal layer 230 of the composite substrate 200.

The first and second electrode tabs 310, 320 may be weld-coupled to the composite substrate 200. The first electrode tab 310 may be overlapped on the first metal layer 220 exposed at the uncoated portion 200b of the composite substrate 200. In addition, the second electrode tab 320 may be overlapped on the second metal layer 230 exposed at the uncoated portion 200b of the composite substrate 200. A welded portion W may be formed by welding overlapping regions of the first electrode tab 310 and the first metal layer 220 and overlapping regions of the second electrode tab 320 and the second metal layer 230.

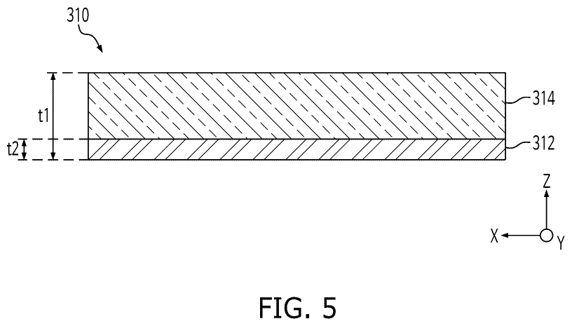

FIG. 5 is a cross-sectional view of the first electrode tab 310 according to some embodiments of the present disclosure. As shown, the first electrode tab 310 may have a double-layer structure. The first electrode tab 310 may include a first substrate layer 312 and a second substrate layer 314 disposed on the first substrate layer 312.

In some embodiments, the first substrate layer 312 and the second substrate layer 314 may be formed of different metallic materials. The first substrate layer 312 may contact a metal layer of the composite substrate. Accordingly, the first substrate layer 312 may be formed of a material having a high welding strength with the metal layer of the composite substrate.

The metal layer of the composite substrate is generally formed of copper, a copper alloy, nickel, a nickel alloy, etc. Additionally, the metal layer of the composite substrate may be formed of aluminum, an aluminum alloy, etc. Accordingly, the first substrate layer 312 may be formed of a material having a high welding strength with the above-mentioned metal-layer materials. Specifically, a welding strength between the first substrate layer 312 and the metal layer of the composite substrate may be set to 1.5 kgf or more.

The welding strength between the first substrate layer 312 and the metal layer of the composite substrate may be higher than a welding strength between the second substrate layer 314 and the metal layer of the composite substrate. Specifically, the first substrate layer 312 may include at least nickel, and the second substrate layer 314 may include at least copper.

A thickness t2 of the first substrate layer 312 may be greater than or equal to 2.5% of a thickness t1 of the first electrode tab 310. The first substrate layer 312 may be plated in the form of a thin film on a plate-shaped layer constituting the second substrate layer 314. Alternatively, the first substrate layer 312 and the second substrate layer 314 may each be fabricated as separate plate-shaped layers and then may be coupled to each other.

The first electrode tab 310 may be coupled to the composite substrate. The first electrode tab 310 may be disposed such that the first substrate layer 312 faces a metal layer of the composite substrate. In addition, the first substrate layer 312 may be weld-coupled to the metal layer of the composite substrate.

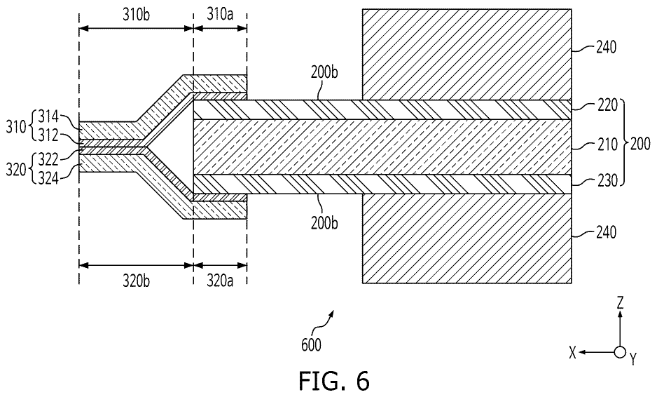

FIG. 6 is a cross-sectional view of an electrode 600 in which the first electrode tab 310 and the second electrode tab 320 are coupled to each other according to some embodiments of the present disclosure. As shown, the electrode 600 may include a composite substrate 200 and first and second electrode tabs 310, 320 coupled to the composite substrate 200. The first electrode tab 310 and the second electrode tab 320 in FIG. 6 may be substantially the same as the first electrode tab 310 in FIG. 5. Components described in or overlapping with FIGS. 1 through 5 are omitted from the description in FIG. 6 for brevity.

The first electrode tab 310 and the second electrode tab 320 may be coupled to the uncoated portion 200b of the composite substrate 200. The first electrode tab 310 may be coupled to the first metal layer 220 where the first metal layer 220 is exposed at the uncoated portion 200b of the composite substrate 200. In addition, the second electrode tab 320 may be coupled to the second metal layer 230 where the second metal layer 230 is exposed at the uncoated portion 200b of the composite substrate 200.

With respect to the first direction (e.g., the X direction) in which the composite substrate 200 extends, the first electrode tab 310 may protrude beyond an end of the composite substrate 200. The first electrode tab 310 may include a first region 310a contacting the first metal layer 220 and a second region 310b protruding beyond the first metal layer 220 with respect to the first direction.

Likewise, the second electrode tab 320 may protrude beyond an end of the composite substrate 200 with respect to the first direction (e.g., the X direction) in which the composite substrate 200 extends. A protruding direction (e.g., a +X direction) of the second electrode tab 320 may be the same as a protruding direction of the first electrode tab 310. The second electrode tab 320 may include a third region 320a contacting the second metal layer 230 and a fourth region 320b protruding beyond the second metal layer 230 with respect to the first direction.

The first electrode tab 310 and the first metal layer 220 may be weld-coupled. The first electrode tab 310 and the first metal layer 220 may be weld-coupled at the first region 310a. In addition, the second electrode tab 320 and the second metal layer 230 may be weld-coupled. The second electrode tab 320 and the second metal layer 230 may be weld-coupled at the third region 320a.

The first electrode tab 310 may include the first substrate layer 312 and the second substrate layer 314 disposed on the first substrate layer 312. The first substrate layer 312 and the second substrate layer 314 may be formed of different metallic materials. In some embodiments, the first substrate layer 312 may include at least nickel, and the second substrate layer 314 may include at least copper.

Similarly, the second electrode tab 320 may include a first substrate layer 322 and a second substrate layer 324 disposed on the first substrate layer 322, and the first substrate layer 322 and the second substrate layer 324 may be formed of different metallic materials. In some embodiments, the first substrate layer 322 may include at least nickel, and the second substrate layer 324 may include at least copper.

During the coupling of the first and second electrode tabs 310, 320 and the composite substrate 200, the first substrate layers 312, 322 of the first and second electrode tabs 310, 320 may be coupled to the first and second metal layers 220, 230 of the composite substrate 200. A welding strength between the first substrate layers 312, 322 and the first and second metal layers 220, 230 may be equal to or higher than a predetermined value. In some embodiments, a welding strength between the first substrate layers 312, 322 and the first and second metal layers 220, 230 may be 1.5 kgf or more.

The first electrode tab 310 and the second electrode tab 320 may be coupled to each other. At least a portion of the second region 310b of the first electrode tab 310 and at least a portion of the fourth region 320b of the second electrode tab 320 may be coupled to each other. Because the first electrode tab 310 and the second electrode tab 320 are coupled, the first metal layer 220 and the second metal layer 230 of the composite substrate 200 may be electrically connected to each other. Accordingly, it is possible to prevent a problem in which current is induced only through one of the first and second metal layers 220, 230 disposed on both surfaces of the composite substrate 200, a problem reducing battery efficiency.

The second substrate layers 314, 324 of the first and second electrode tabs 310, 320 may be formed of materials having high electrical conductivity. An electrical conductivity of the second substrate layers 314, 324 may be higher than an electrical conductivity of the first substrate layers 312, 322, but the present disclosure is not limited thereto.

Table 1 below shows experimental results of welding strength measurements between copper and members formed of different metallic materials. In the case of the nickel-plated member used in the experiment, nickel was plated on a copper member, and a ratio of the nickel-plating layer was set to 2.5% of the total thickness.

TABLE 1

| | | | Ni-Plated |
|---|---|---|---|
| | Cu | Ni | Cu |
| Welding strength | 0.5-0.6 | 3.28 | 2.18 |
| (kgf) | | | |

According to Table 1, the welding strength of the nickel tab (e.g., 3.28 kgf) and the welding strength of the nickel-plated tab (e.g., 2.18 kgf) exceed the welding strength required for coupling the first and second electrode tabs 310, 320 and the composite substrate 200 (e.g., 1.5 kgf). In contrast, the welding strength of the copper tab (e.g., 0.5-0.6 kgf) is smaller than the welding strength required for coupling the first and second electrode tabs 310, 320 and the composite substrate 200 (e.g., 1.5 kgf).

In view of the above results of Table 1, by configuring the first and second electrode tabs 310, 320 in a double-layer structure and forming, as surfaces contacting the first and second metal layers 220, 230 of the composite substrate 200, first substrate layers 312, 322 plated with nickel, the first and second electrode tabs 310, 320 can be stably coupled to the composite substrate 200. In addition, because the second substrate layers 314, 324, which do not contact the first and second metal layers 220, 230 of the composite substrate 200, are formed of materials having high electrical conductivity, stable current flow can be achieved between the composite substrate 200 and the first and second electrode tabs 310, 320, or between the first electrode tab 310 and the second electrode tab 320.

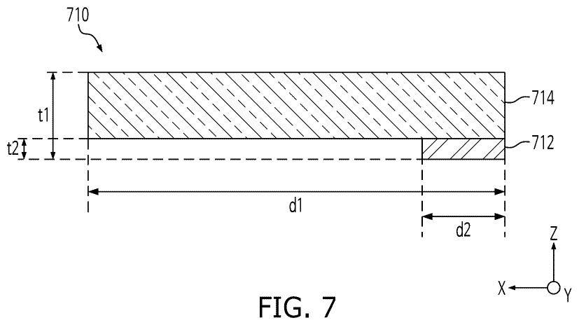

FIG. 7 is a cross-sectional view of a first electrode tab 710 according to some embodiments of the present disclosure. As shown, the first electrode tab 710 may have a double-layer structure. The first electrode tab 710 may include a first substrate layer 712 and a second substrate layer 714 disposed on the first substrate layer 712.

The first substrate layer 712 and the second substrate layer 714 may be formed of different metallic materials. The first substrate layer 712 may contact a metal layer of the composite substrate. Accordingly, the first substrate layer 712 may be formed of a material having a high welding strength with the metal layer of the composite substrate. Specifically, the first substrate layer 712 may include at least nickel, and the second substrate layer 714 may include at least copper.

A thickness t2 of the first substrate layer 712 may be greater than or equal to 2.5% of a thickness t1 of the first electrode tab 710. The first substrate layer 712 may be plated as a thin film on a plate-shaped layer constituting the second substrate layer 714. Alternatively, the first substrate layer 712 and the second substrate layer 714 may each be fabricated as separate plate-shaped layers and then coupled to each other.

With respect to a first direction in which the composite substrate extends (for example, the X direction), a width d2 of the first substrate layer may be smaller than a width d1 of the second substrate layer. Specifically, the width d2 of the first substrate layer may be from about 3 mm to about 5 mm. In addition, the width d1 of the second substrate layer may be about 15 mm.

The first electrode tab 710 may be coupled to the composite substrate. The first substrate layer 712 of the first electrode tab 710 may face a metal layer of the composite substrate. In addition, the first substrate layer 712 may be weld-coupled to the metal layer of the composite substrate.

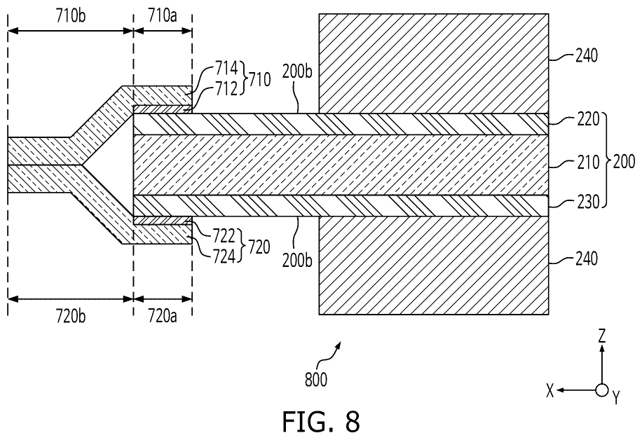

FIG. 8 is a cross-sectional view of an electrode 800 in which the first electrode tab 710 and a second electrode tab 720 are coupled to each other according to some embodiments of the present disclosure. As shown, the electrode 800 may include the composite substrate 200 and first and second electrode tabs 710, 720 coupled to the composite substrate 200. The first electrode tab 710 and the second electrode tab 720 in FIG. 8 may be substantially the same as the first electrode tab 710 in FIG. 7. Components described in, or overlapping with, FIGS. 1 through 7 are omitted from the description of FIG. 8 for brevity.

With respect to the first direction in which the composite substrate 200 extends (for example, the X direction), the first electrode tab 710 may protrude beyond an end of the composite substrate 200. The first electrode tab 710 may include a first region 710a contacting the first metal layer 220 and a second region 710b protruding beyond the first metal layer 220 with respect to the first direction.

Likewise, the second electrode tab 720 may protrude beyond the end of the composite substrate 200 with respect to the first direction (for example, the X direction) in which the composite substrate 200 extends. The second electrode tab 720 may include a third region 720a contacting the second metal layer 230 and a fourth region 720b protruding beyond the second metal layer 230 with respect to the first direction.

The first electrode tab 710 and the first metal layer 220 may be weld-coupled. The first electrode tab 710 and the first metal layer 220 may be weld-coupled at the first region 710a. In addition, the second electrode tab 720 and the second metal layer 230 may be weld-coupled. The second electrode tab 720 and the second metal layer 230 may be weld-coupled at the third region 720a.

With respect to the first direction in which the composite substrate 200 extends (for example, the X direction), a width of the first region 710a may correspond to a width of a welded portion at which the first electrode tab 710 and the first metal layer 220 are welded. Similarly, with respect to the first direction, a width of the third region 720a may correspond to a width of a welded portion at which the second electrode tab 720 and the second metal layer 230 are welded. In some embodiments, the widths of the first region 710a and the third region 720a may be from about 3 mm to about 5 mm, but the present disclosure is not limited thereto.

The first and second electrode tabs 710, 720 may include first substrate layers 712, 722 and second substrate layers 714, 724 disposed on the first substrate layers 712, 722 respectively. The first substrate layers 712, 722 and the second substrate layers 714, 724 may be formed of different metallic materials. Specifically, the first substrate layers 712, 722 may include at least nickel, and the second substrate layers 714, 724 may include at least copper. The first substrate layer 712 of the first electrode tab 710 may be located in the first region 710a. In addition, the first substrate layer 722 of the second electrode tab 720 may be located in the third region 720a. Accordingly, during coupling of the first and second electrode tabs 710, 720 and the composite substrate 200, the first substrate layers 712, 722 of the first and second electrode tabs 710, 720 may be coupled to the first and second metal layers 220, 230 of the composite substrate 200.

The first electrode tab 710 and the second electrode tab 720 may be coupled to each other. At least a portion of the second region 710b of the first electrode tab 710 and at least a portion of the fourth region 720b of the second electrode tab 720 may be coupled to each other. The second substrate layer 714 of the first electrode tab 710 and the second substrate layer 724 of the second electrode tab 720 may be coupled to each other. Because the second substrate layers 714, 724 (made of, for example, copper), which have electrical conductivities higher than those of the first substrate layers 712, 722 (made of, for example, nickel), are coupled, an advantage can be achieved in terms of electrical conductivity.

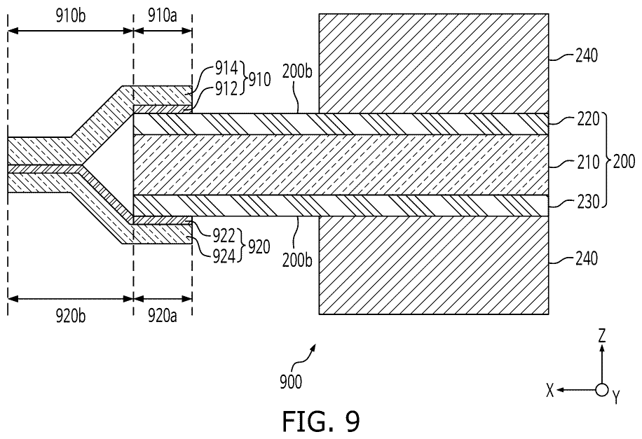

FIG. 9 is a cross-sectional view of an electrode 900 in which a first electrode tab 910 and a second electrode tab 920 are coupled to each other according to some embodiments of the present disclosure. As shown, the electrode 900 may include the composite substrate 200 and first and second electrode tabs 910, 920 coupled to the composite substrate 200. The first electrode tab 910 in FIG. 9 may be substantially the same as the first electrode tab 710 in FIG. 7. In addition, the second electrode tab 920 in FIG. 9 may be substantially the same as the first electrode tab 310 in FIG. 5. Components described in, or overlapping with, FIGS. 1 through 8 are omitted from the description of FIG. 9 for brevity.

With respect to the first direction in which the composite substrate 200 extends (for example, the X direction), the first electrode tab 910 may protrude beyond an end of the composite substrate 200. The first electrode tab 910 may include a first region 910a contacting the first metal layer 220 and a second region 910b protruding beyond the first metal layer 220 with respect to the first direction. A first substrate layer 912 including nickel may be located in the first region 910a.

The second electrode tab 920 may protrude beyond the end of the composite substrate 200 with respect to the first direction in which the composite substrate 200 extends (for example, the X direction). The second electrode tab 920 may include a third region 920a contacting the second metal layer 230 and a fourth region 920b protruding beyond the second metal layer 230 with respect to the first direction. A first substrate layer 922 including nickel may be located in the third region 920a and in at least a portion of the fourth region 920b.

The first electrode tab 910 and the second electrode tab 920 may be coupled to each other. At least a portion of the second region 910b of the first electrode tab 910 and at least a portion of the fourth region 920b of the second electrode tab 920 may be coupled to each other. The second substrate layer 914 of the first electrode tab 910 and the first substrate layer 922 of the second electrode tab 920 may be coupled to each other. Because the first substrate layer 922 (for example, nickel) and the second substrate layer 914 (for example, copper) are weld-coupled to each other, a stable welding strength between the first electrode tab 910 and the second electrode tab 920 may be achieved.

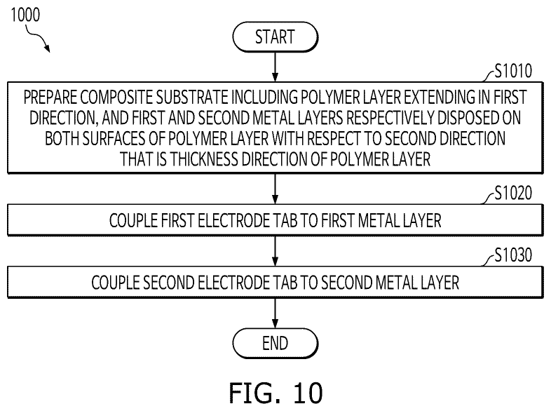

FIG. 10 is a flowchart illustrating an electrode-manufacturing method 1000 according to some embodiments of the present disclosure. The electrode-manufacturing method 1000 may start with preparing a composite substrate including a polymer layer extending in a first direction and, with respect to a second direction that is a thickness direction of the polymer layer, first and second metal layers respectively disposed on both surfaces of the polymer layer S1010. An active material may be applied on the composite substrate. In some embodiments, the composite substrate may include a coated portion in which an active material layer is disposed on the first metal layer or the second metal layer and an uncoated portion positioned at an end portion of the composite substrate with respect to the first direction and exposing the first metal layer or the second metal layer.

Then, a first electrode tab may be coupled to the first metal layer S1020. The first electrode tab may include a first substrate layer contacting the first metal layer or the second metal layer and a second substrate layer disposed on the first substrate layer. The first substrate layer of the first electrode tab may be weld-coupled to the uncoated portion of the composite substrate.

Next, a second electrode tab may be coupled to the second metal layer S1030. The second electrode tab may include a first substrate layer contacting the first metal layer or the second metal layer and a second substrate layer disposed on the first substrate layer. In some embodiments, a thickness of the first substrate layer may be greater than or equal to 2.5% of a thickness of the first electrode tab. The first substrate layer of the second electrode tab may be weld-coupled to the uncoated portion of the composite substrate.

A welding strength between the first metal layer or the second metal layer and the first substrate layer may be higher than a welding strength between the first metal layer or the second metal layer and the second substrate layer. In some embodiments, the first substrate layer may include at least nickel, and the second substrate layer may include at least copper.

The first electrode tab may include a first region contacting the first metal layer and, with respect to the first direction, a second region protruding beyond the first metal layer. The second electrode tab may include a third region contacting the second metal layer and, with respect to the first direction, a fourth region protruding beyond the second metal layer. In some embodiments, the first substrate layer of the first electrode tab may be located in the first region of the first electrode tab, and the first substrate layer of the second electrode tab may be located in the third region of the second electrode tab. With respect to the first direction, a width of the first substrate layer may be from about 3 mm to about 5 mm. In other embodiments, the first substrate layer of the first electrode tab may be located in the first region of the first electrode tab, and the first substrate layer of the second electrode tab may be located in at least a portion of the third region of the second electrode tab and at least a portion of the fourth region of the second electrode tab.

Then, at least a portion of the first electrode tab in the second region of the first electrode tab and at least a portion of the second electrode tab in the fourth region of the second electrode tab may be coupled to each other.

The flowchart of FIG. 10 and the above-described explanation illustrates merely one or more examples of a method of the present disclosure, and the present disclosure is not limited to the flowchart of FIG. 10 and the above-described explanation. One or more steps in the flowchart and the above-described explanation may be added, changed, or deleted; an order of one or more steps may be changed; or one or more steps may be performed simultaneously.

Although the present disclosure has been described above with respect to embodiments thereof, the present disclosure is not limited thereto. Various modifications and variations can be made thereto by those skilled in the art.

DESCRIPTION OF SOME REFERENCE SYMBOLS

| | |
|---|---|
| 100: battery | 110: electrode assembly |
| 112: first electrode | 114: second electrode |
| 116: separator | 122: protective tape |
| 124: protective tape | 126: protective tape |
| 130: electrode tab | 130_1: first electrode tab |
| 130_2: second electrode tab | 142: first strip terminal |
| 144: second strip terminal | 146: tab film |
| 150: case | |

What is claimed is:

1. An electrode comprising:
a composite substrate including:
a polymer layer extending in a first direction;
a first metal layer disposed on first surface of the polymer layer, the first surface being orthogonal to a second direction; and
a second metal layer disposed on a second surface of the polymer layer, the second surface being orthogonal to the second direction;
a first electrode tab coupled to the first metal layer; and
a second electrode tab coupled to the second metal layer,
wherein the first electrode tab includes a first substrate layer welded to the first metal layer, and a second substrate layer disposed on the first substrate layer of the first electrode tab,
wherein the second electrode tab includes a first substrate layer welded to the second metal layer, and a second substrate layer disposed on the first substrate layer of the second electrode tab, and
wherein a welding strength between the first substrate layer of the first electrode tab and the first metal layer or between the first substrate layer of the second electrode tab and the second metal layer is greater than a welding strength between the second substrate layer of the first electrode tab and the first metal layer or between the second substrate layer of the second electrode tab and the second metal layer.

2. The electrode according to claim 1, wherein the first substrate layer of the first electrode tab and the first substrate layer of the second electrode tab include at least nickel, and
wherein the second substrate layer of the first electrode tab and the second substrate layer of the second electrode tab include at least copper.

3. The electrode according to claim 1, wherein, with respect to the second direction, a thickness of the first substrate layer of the first electrode tab is greater than or equal to 2.5% of a thickness of the first electrode tab.

4. The electrode according to claim 1, wherein the composite substrate further includes:
a coated portion of the first metal layer and the second metal layer where an active material layer is located on the first metal layer or on the second metal layer; and
an uncoated portion of the first metal layer and the second metal layer positioned at an end portion of the composite substrate with respect to the first direction and exposing the first metal layer or the second metal layer, and
wherein the first substrate layer of the first electrode tab and the first substrate layer of the second electrode tab are welded to the uncoated portion.

5. The electrode according to claim 1, wherein the first electrode tab includes a first region where the first electrode tab contacts the first metal layer, and a second region where the first electrode tab protrudes beyond the first metal layer with respect to the first direction, and
wherein the second electrode tab includes a third region where the second electrode tab contacts the second metal layer, and a fourth region where the second electrode tab protrudes beyond the second metal layer with respect to the first direction.

6. The electrode according to claim 5, wherein the first substrate layer of the first electrode tab is positioned in the first region of the first electrode tab, and
wherein the first substrate layer of the second electrode tab is positioned in the third region of the second electrode tab.

7. The electrode according to claim 6, wherein, with respect to the first direction, a width of the first substrate layer of the first electrode tab and a width of the first substrate layer of the second electrode tab are from about 3 mm to about 5 mm.

8. The electrode according to claim 5, wherein the first substrate layer of the first electrode tab is positioned in the first region of the first electrode tab, and
wherein the first substrate layer of the second electrode tab is positioned in at least a portion of the third region of the second electrode tab and at least a portion of the fourth region of the second electrode tab.

9. The electrode according to claim 5, wherein at least a portion, of the first electrode tab, in the second region and at least a portion, of the second electrode tab, in the fourth region are coupled to each other.

10. The electrode according to claim 1, wherein an electrical conductivity of the second substrate layer of the first electrode tab is greater than an electrical conductivity of the first substrate layer of the first electrode tab, or an electrical conductivity of the second substrate layer of the second electrode tab is greater than an electrical conductivity of the first substrate layer of the second electrode tab.

11. A method of manufacturing an electrode, comprising:
layering a composite substrate including:
a polymer layer extending in a first direction;
a first metal layer disposed on a first surface of the polymer layer, the first surface being orthogonal to a second direction; and
a second metal layer disposed on a second surface of the polymer layer, the second surface being orthogonal to the second direction;
coupling a first electrode tab to the first metal layer, the first electrode tab including a first substrate layer and a second substrate layer;
coupling a second electrode tab to the second metal layer, the second electrode tab including a first substrate layer and a second substrate layer;
welding the first substrate layer of the first electrode tab to the first metal layer;
layering the second substrate layer of the first electrode tab on the first substrate layer of the first electrode tab;
welding the first substrate layer of the second electrode tab to the second metal layer; and
layering the second substrate layer of the second electrode tab on the first substrate layer of the second electrode tab,
wherein a welding strength between the first substrate layer of the first electrode tab and the first metal layer or between the first substrate layer of the second electrode tab and the second metal layer is greater than a welding strength between the second substrate layer of the first electrode tab and the first metal layer or between the second substrate layer of the second electrode tab and the second metal layer.

12. The method according to claim 11, further comprising:
forming the first substrate layer of the first electrode tab and the first substrate layer of the second electrode tab at least with nickel; and
forming the second substrate layer of the first electrode tab and the second substrate layer of the second electrode tab at least with copper.

13. The method according to claim 11, further comprising configuring, with respect to the second direction, a thickness of the first substrate layer of the first electrode tab to be greater than or equal to 2.5% of a thickness of the first electrode tab.

14. The method according to claim 11, wherein preparing the composite substrate includes applying an active material on the composite substrate so that the composite substrate includes:
a coated portion of the first metal layer and the second metal layer where an active material layer is located on the first metal layer or on the second metal layer; and
an uncoated portion of the first metal layer and the second metal layer positioned at an end portion of the composite substrate with respect to the first direction and exposing the first metal layer or the second metal layer.

15. The method according to claim 14, wherein coupling the first electrode tab to the first metal layer includes welding the first substrate layer of the first electrode tab to the uncoated portion.

16. The method according to claim 11, wherein the first electrode tab includes a first region and a second region,
wherein the second electrode tab includes a third region and a fourth region, and
wherein the method further comprises:
positioning the first electrode tab so that a portion of the first electrode tab in the first region contacts the first metal layer;
configuring the first electrode tab so that a portion of the first electrode tab in the second region protrudes beyond the first metal layer with respect to the first direction;
positioning the second electrode tab so that a portion of the second electrode tab in the third region contacts the second metal layer; and
configuring the second electrode tab so that a portion of the second electrode tab in the fourth region protrudes beyond the second metal layer with respect to the first direction.

17. The method according to claim 16, further comprising positioning the first substrate layer of the first electrode tab in the first region of the first electrode tab; and
positioning the first substrate layer of the second electrode tab in the third region of the second electrode tab.

18. The method according to claim 17, further comprising configuring the first substrate layer of the first electrode tab and the first substrate layer of the second electrode tab to each have a width, with respect to the first direction, from about 3 mm to about 5 mm.

19. The method according to claim 16, further comprising positioning the first substrate layer of the first electrode tab to be in the first region of the first electrode tab; and
positioning the first substrate layer of the second electrode tab to be in at least a portion of the third region of the second electrode tab and at least a portion of the fourth region of the second electrode tab.

20. The method according to claim 16, further comprising coupling at least a portion, of the first electrode tab, in the second region and at least a portion, of the second electrode tab, in the fourth region to each other.
